(19) United States
(12) Patent Application Publication
(10) Pub. No.: US 2025/0073620 A1
(43) Pub. Date: Mar. 6, 2025

(54) Water Quality Purification Assembly and Refrigeration Device

(71) Applicants: Hefei Midea Refrigerator Co., Ltd., Hefei (CN); Hefei Hualing Co., Ltd., Hefei (CN); Midea Group Co., Ltd., Foshan (CN)

(72) Inventors: Yunyun XIE, Hefei (CN); Tuo LIU, Hefei (CN); Lei ZHANG, Hefei (CN)

(21) Appl. No.: 18/948,327

(22) Filed: Nov. 14, 2024

Related U.S. Application Data
(63) Continuation of application No. PCT/CN2022/101606, filed on Jun. 27, 2022.

(30) Foreign Application Priority Data
May 16, 2022 (CN) 202210531484.7

(51) Int. Cl. B01D 29/15; B01D 35/147; F25D 23/12

(52) U.S. Cl. CPC B01D 29/15; B01D 35/147; F25D 23/126; B01D 2201/0423; B01D 2201/167; B01D 2201/307; F25D 2323/121

(57) ABSTRACT

A water quality purification assembly includes a housing assembly, a filter element, an inner housing, and a support member. An accommodation cavity is constructed inside the housing assembly; the filter element is disposed in the accommodation cavity; the inner housing is disposed between the housing assembly and the filter element, and a first flow channel is constructed between the inner housing and the housing assembly; a second flow channel is constructed between the inner housing and the filter element. The support member supports the filter element, a water storage cavity is constructed between the support member and a bottom wall of the housing assembly, and the water storage cavity is separately communicated with the first flow channel and the second flow channel.

### CROSS-REFERENCES TO RELATED APPLICATIONS

The present application is a continuation of International (PCT) Patent Application No. PCT/CN2022/101606 filed on Jun. 27, 2022, which claims priority to Chinese patent application No. 202210531484.7 filed on May 16, 2022, entitled “Water Quality Purification Assembly and Refrigeration Device,” which is hereby incorporated by reference in its entirety.

### FIELD

The present application relates to the field of refrigeration devices, and in particular, to a water purification assembly and a refrigeration device.

### BACKGROUND

In the related art, a purification system of a refrigeration device supplies a part of water purified by a water purification assembly to an ice maker. The other part of the water is stored in a water tank, and is then supplied from the water tank to a dispenser for use by a user.

Since the water tank is independently provided from the water purification assembly, the entire purification system has a larger structural volume and occupies more space. In addition, the water tank and the water purification assembly are communicated through connect pipes and connect joints, which may be easily exposed to the risk of water leakage.

### SUMMARY

The present application aims to solve at least one of the problems existing in the related art. The present application provides a water purification assembly that not only has a purification function, but also has a water storage function. This water purification assembly has a compact structure, occupies little space, and has fewer connect points between components, which may effectively prevent water leakage.

The present application further provides a refrigeration device.

According to the water purification assembly provided by some embodiments of the present application, the water purification assembly includes: an outer shell assembly, where an accommodation chamber is provided inside the outer shell assembly; a filter element, provided inside the accommodation chamber; an inner shell, provided between the outer shell assembly and the filter element, where a first flow channel is provided between the inner shell and the outer shell assembly, and a second flow channel is provided between the inner shell and the filter element; and a support member, adapted to support the filter element, where a water storage chamber is provided between the support member and a bottom wall of the outer shell assembly, and the water storage chamber is communicated with the first flow channel and the second flow channel respectively.

According to the water purification assembly of some embodiments of the present application, by providing the water storage chamber for water storage in the water purification assembly, the water purification assembly is more integrated, and the water purification assembly not only has a purify function, but also has a water storage function. The water tank, which is provided at independently from water purification assembly in the related art, is replaced, that is, the water tank is canceled, thereby simplifying a structural design and reducing space occupied by the structure. Meanwhile, connect pipes and connect joints between the water tank and the water purification assembly are canceled, which effectively avoids structural leakage risks, thereby making a product more reliable.

According to some embodiments of the present application, the support member is provided at an inner wall surface of the outer shell assembly, and the water storage chamber is formed inside the support member; or the support member is provided at an inner wall surface of the inner shell, and the water storage chamber is composed of the support member and at least one of the inner shell and the outer shell assembly.

According to some embodiments of the present application, the support member includes a support member body and a limit block, where the limit block is provided at an outer side wall of the support member body and is suitable for abutting against the inner wall surface of the outer shell assembly, where the support member body has a first end and a second end, the first end is formed with a first water inlet, the first water inlet is communicated with the first flow channel, and the second end is adapted to abut against the filter element.

According to some embodiments of the present application, a first block member is provided at a second end of the support member body, and the first block member abuts against an end portion of the filter element.

According to some embodiments of the present application, the support member body and the first block member are integrally formed, where a block groove is provided at a side of the first block member facing the filter element, and the filter element is embedded in the block groove; and a protrusion is provided inside the block groove, a third flow channel is provided inside the filter element, and the protrusion extends into the third flow channel.

According to some embodiments of the present application, a limit portion is provided at an outer side wall of the support member body, and the inner shell abuts against the limit portion; and a first water outlet is provided between the limit portion and a second end of the support member body, and the first water outlet is communicated with the second flow channel.

According to some embodiments of the present application, the outer shell assembly includes a first outer shell and a second outer shell, and the first outer shell is connected to and at least partially seals the second outer shell.

According to some embodiments of the present application, at least one of the first flow channel and the second flow channel is provided with a flow guide portion, and the flow guide portion extends along a central axis of the inner shell to form a spiral structure.

According to some embodiments of the present application, the water purification assembly further includes: a socket assembly, where the socket assembly includes: a socket main body, provided with a main water inlet and a main water outlet, where a bypass chamber, a dispensing chamber and an operation chamber are provided inside the socket main body, the bypass chamber is communicated with the operation chamber through the dispensing chamber, and the operation chamber is detachably connected to the water purification assembly; and a valve core assembly, movably provided inside the dispensing chamber and adapted to switch between a first position and a second position, where in case that the valve core assembly is at the first position, the valve core assembly blocks the dispensing chamber and the operation chamber, and the main water inlet is communicated with the main water outlet through the dispensing chamber and the bypass chamber; or in case that the valve core assembly is at the second position, the valve core assembly blocks the dispensing chamber and the bypass chamber, and the main water inlet is communicated with the main water outlet through the dispensing chamber and the operation chamber.

According to some embodiments of the present application, the water purification assembly further includes: a water-stop assembly, where a water-stop chamber is provided inside the outer shell assembly, the water-stop assembly is movably provided at the water-stop chamber, and the water-stop assembly is adapted to switch between a first position and a second position, where a first passage is provided outside the water-stop assembly, a second passage is provided inside the water-stop assembly, and a check valve is provided inside the second passage, where in case that the water-stop assembly is at the first position, the water-stop assembly blocks the first passage, and the check valve blocks the second passage; or in case that the water-stop assembly is at the second position, the water-stop assembly conducts the first passage, and the check valve conducts the second passage.

According to the refrigeration device provided by the present application, the refrigeration device includes a refrigeration compartment, a water-use component, and any of the above-mentioned water purification assemblies, where the water purification assembly is provided inside the refrigeration compartment, and a main water outlet of the water purification assembly is communicated with the water-use component.

According to the refrigeration device of some embodiments of the present application, by providing the water storage chamber for water storage in the water purification assembly, the water purification assembly is more integrated, and the water purification assembly not only has a purify function, but also has a water storage function. The water tank structure, which is provided independently from water purification assembly in the related art, is replaced, that is, the water tank is canceled, thereby simplifying a structural design and reducing space occupied by the structure. Meanwhile, connect pipes and connect joints between the water tank and the water purification assembly are canceled, which effectively avoids structural leakage risks, thereby making a product more reliable.

According to some embodiments of the present application, the refrigeration device further includes a valve assembly, where a liquid inlet of the valve assembly is communicated with the main water outlet of the water purification assembly, and the liquid outlet of the valve assembly is communicated with at least one water-use component.

According to some embodiments of the present application, the water-use component includes a first ice maker, a second ice maker and a dispenser; and the refrigeration compartment includes a refrigerator compartment and a freezer compartment, the first ice maker is provided at the refrigerator compartment, the second ice maker is provided at the freezer compartment, and the dispenser is provided at a door body of the refrigeration device.

Additional aspects and advantages of the present application would be set forth in part in the description which follows and, in part, will be apparent from the description, or may be learned by practice of the presented application.

### BRIEF DESCRIPTION OF THE DRAWINGS

In order to clearly illustrate the solutions according to the present application, the accompanying drawings used in the description of some embodiments of the present application are briefly introduced below. It should be noted that, the drawings in the following description are only part embodiments of the present application. For those of ordinary skill in the art, other drawings may also be obtained based on these drawings without creative efforts.

FIG. 1 is a cross-sectional view of a water purification assembly according to some embodiments of the present application;

FIG. 2 is a schematic diagram of an exploded structure of a water purification assembly according to some embodiments of the present application;

FIG. 3 is a front view of a water purification assembly according to some embodiments of the present application;

FIG. 4 is a schematic diagram showing a state of a socket assembly of a water purification assembly at a first position according to some embodiments of the present application;

FIG. 5 is a schematic diagram showing a state of a socket assembly of a water purification assembly at a second position according to some embodiments of the present application;

FIG. 6 is a schematic diagram showing a state of a water-stop assembly of a water purification assembly at a first position according to some embodiments of the present application;

FIG. 7 is a schematic diagram showing a state of a water-stop assembly of a water purification assembly at a second position according to some embodiments of the present application;

FIG. 8 is a schematic structural diagram of a refrigeration device according to some embodiments of the present application; and

FIG. 9 is a schematic diagram of a water supply system of a refrigeration device according to some embodiments of the present application.

### REFERENCE NUMERALS

100: water purification assembly;
101: outer shell assembly; 1011: first outer shell; 1011-1: first seal ring; 1011-2: water-stop chamber; 1012: second outer shell; 1013: first flow channel; 1014: second flow channel;
102: inner shell; 1021: flow guide portion; 1022: limit protrusion; 1023: second seal ring; 1024: fixed portion; 1025: guide protrusion;
103: filter element; 1031: third flow channel; 1032: second block member; 1032-1: third seal ring;
104: support member; 1041: water storage chamber; 1042: support member body; 1042-1: first end; 1042-2: second end; 1042-3: first water inlet; 1042-4: first water outlet; 1042-5: limit portion; 1043: limit block; 1044: first block member; 1044-1: block groove; 1044-2: protrude portion;
105: socket assembly; 1051: main water inlet; 1052: main water outlet; 1053: bypass chamber; 1054: dispensing chamber; 1054-1: first dispensing chamber body; 1054-2: second dispensing chamber body; 1055: operation chamber; 1056: valve core assembly; 1056-1: first eject rod; 1056-2: second eject rod; 1056-3: first elastic member; 1056-4: second elastic member; 1057: fourth seal ring; 1058: fifth seal ring;
106: fixed seat; 1061: first seat body; 1062: second seat body;
107: water-stop assembly; 1071: water-stop shell body; 1071-1: limit groove; 1071-2: sixth seal ring; 1071-3: seventh seal ring; 1072: elastic member; 1073: check valve; 1074: first passage; 1075: second passage; 1076: seal protrusion;
200: valve assembly;
300: first waterway;
400: second waterway; 401: first sub-water supply pipe; 402: second sub-water supply pipe; 403: second water supply pipe;
500: water-use component; 501: first ice maker; 502: second ice maker; 503: dispenser;
600: refrigeration device; 601: refrigerator compartment; 602: freezer room; 603: door body.

### DETAILED DESCRIPTION

Embodiments of the present application are further described in detail below with reference to the drawings and embodiments. The following embodiments are intended to illustrate the present application, but are not intended to limit the scope of the present application.

In the description of some embodiments of the present application, it should be noted that the orientations or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing some embodiments of the present application and simplifying the description, rather than indicating or implying that the device or component stated must have a particular orientation, or is constructed or operated in a particular orientation, and thus is not to be construed as limiting some embodiments of the present application. Moreover, the terms “first”, “second”, “third”, and the like are used for descriptive purposes only and are not to be construed as indicating or implying relative importance.

In the description of the present application, it should be noted that, unless explicitly specified and defined otherwise, the terms “connected to” and “connected” shall be understood broadly, for example, it may be either fixedly connected or detachably connected, or may be integrated; it may be either mechanically connected, or electrically connected; it may be either directly connected, or indirectly connected through an intermediate medium. The specific meanings of the terms above in embodiments of the present application may be understood by a person skilled in the art in accordance with specific conditions.

In some embodiments of the present application, unless otherwise clearly stated and defined, the first feature being located “on” or “under” the second feature means that the first feature is in direct contact with the second feature or the first feature is in contact with the second feature by an intervening media. In addition, the first feature is “on”, “above” and “over” the second feature can refer to that the first feature is directly above or obliquely above the second feature, or simply refer to that the level height of the first feature is higher than that of the second feature. The first feature is “under”, “below” and “beneath” the second feature can refer to that the first feature is directly below or obliquely below the second feature, or simply refer to that the level height of the first feature is lower than that of the second feature.

In the description of this specification, the description with reference to the terms “some embodiments”, “some embodiments”, “example”, “specific example”, or “some examples” etc. means that the specific features, structures, materials or characteristics described in conjunction with some embodiments or example are included in at least one embodiment or example of some embodiments of the present application. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may integrate and combine the different embodiments or examples described in this specification and the features of the different embodiments or examples, without contradiction.

The water purification assembly 100 provided by the present application is suitable for refrigeration device such as refrigerators, ice bars, freezers, wine cabinets, and refrigeration cabinets, etc. The water purification assembly 100 provided by the present application is described in detail below with reference to specific embodiments.

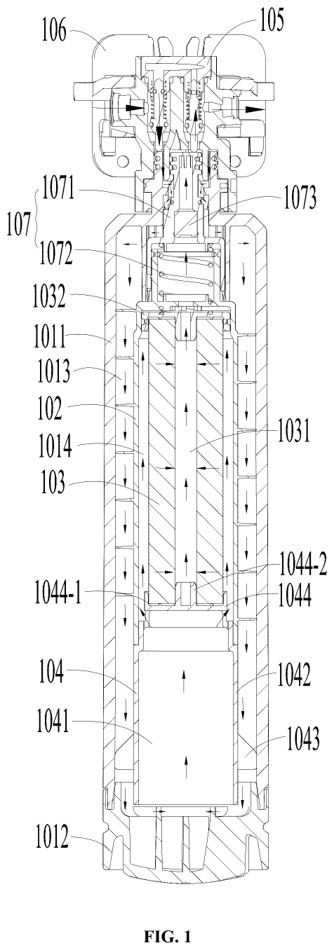

Referring to FIG. 1, the present application provides a water purification assembly 100. The water purification assembly 100 includes an outer shell assembly 101, a filter element 103, an inner shell 102 and a support member 104. An accommodation chamber is provided inside the outer shell assembly 101. The filter element 103 is provided in the accommodation chamber. The inner shell 102 is provided between the outer shell assembly 101 and the filter element 103, and a first flow channel 1013 for flowing water body is provided between the inner shell 102 and the outer shell assembly 101. A second flow channel 1014 for allowing water body flow is provided between the inner shell 102 and the filter element 103.

The support member 104 is mainly used for supporting the filter element 103 in axial direction, so that there is a certain space between the filter element 103 and a bottom wall of the outer shell assembly 101, that is, a water storage chamber 1041 is provided between the filter element 103 and the bottom wall of the outer shell assembly 101. The water storage chamber 1041 is communicated with the first flow channel 1013 and the second flow channel 1014 respectively. A third flow channel 1031 is provided inside the filter element 103, which is equivalent to that, the filter element 103 is located between the second flow channel 1014 and the third flow channel 1031.

The first flow channel 1013 may be either an inlet flow channel or an outlet flow channel, the second flow channel 1014 may be either an inlet flow channel or an outlet flow channel, and the third flow channel 1031 may also be either an inlet flow channel or an outlet flow channel.

In case that both the first flow channel 1013 and the second flow channel 1014 are inlet flow channels, and the third flow channel 1031 is an outlet flow channel, the first flow channel 1013 may be communicated with a main water inlet 1051 of the water purification assembly 100, and the third flow channel 1031 may be communicated with a main water outlet 1052 of the water purification assembly 100.

During the operating procedure of the water purification assembly 100, the main water inlet 1051 is communicated with an external water source, and the water body flows from the main water inlet 1051 into the first flow channel 1013, and enters the water storage chamber 1041 through the first flow channel 1013 for storage. When a user uses purified water, the water stored in the water storage chamber 1041 first flows from the water storage chamber 1041 into the second flow channel 1014, enters the third flow channel 1031 from the second flow channel 1014 through the filter element 103, is sent to the main water outlet 1052 by the third flow channel 1031, and finally flows out from the main water outlet 1052.

It may be understood that by providing the water storage chamber 1041 for water storage and inner water passages in the water purification assembly 100, the water purification assembly 100 is more integrated, and the water purification assembly 100 not only has a purify function, but also has a water storage function. The water tank structure, which is provided independently from water purification assembly 100 in the related art, is replaced, that is, the water tank is canceled, thereby simplifying a structural design and reducing space occupied by the structure. Meanwhile, connect pipes and connect joints between the water tank and the water purification assembly 100 are canceled, which effectively avoids structural leakage risks, thereby making a product more reliable.

Referring to FIG. 1, it may be understood that the support member 104 may be provided at an inner wall surface of the outer shell assembly 101, and the water storage chamber 1041 is formed inside the support member 104. This is equivalent to that the support member 104 is clamped or lapped at the inner wall surface of the outer shell assembly 101, to prevent the filter element 103 from continuing to extend into the bottom wall of the outer shell assembly 101. There is certain space between the bottom wall of the outer shell assembly 101 and the support member 104, which then forms the water storage chamber 1041.

After the water body enters the water storage chamber 1041 through the first flow channel 1013, the water body may be temporarily stored in the water storage chamber 1041. The water storage chamber 1041 is equivalent to a water tank for water storage. Part of the water body in the water storage chamber 1041 enters the second flow channel 1014, and then penetrates from the second flow channel 1014 into the filter element 103 for filtering. The water body filtered by the filter element 103 flows out from the third flow channel 1031 inside the filter element 103.

By integrating the water storage chamber 1041 in the water purification assembly 100 for water storage, the water tank structure is canceled. Meanwhile, the connect pipes and the connect joints between the water tank and the water purification assembly 100 are also canceled, thereby simplifying the structure, reducing the space occupied by the structure and effectively avoiding the risk of water leakage. In addition, when purifying the water body, since the water storage chamber 1041 is integrated inside the water purification assembly 100, an input side of the filter element 103 is fully immersed in the water environment, ensuring that the filter element 103 has a better purification effect on the water.

Referring to FIG. 1, it may be further understood that the structural shape of the support member 104 is compatible with the structural shapes of the filter element 103 and the inner shell 102. In case that the inner shell 102 and the filter element 103 are both cylindrical structures, the support member 104 may also be a cylindrical structure. The support member 104 is fixedly provided at an inner wall surface of the inner shell 102. One side of the support member 104 may abut against the filter element 103 for blocking an end of the filter element 103. Another side of the support member 104 together with part of the inner wall surface of the outer shell assembly 101 and the bottom wall of the outer shell assembly 101 may form a space for water storage, that is, the water storage chamber 1041.

Meanwhile, a stopper (not shown in the figure) may be provided at the inner wall surface of the outer shell assembly 101 to limit an axial support of the inner shell 102, and then an end surface of one end of the inner shell 102 is flush with a surface of a side of the support member 104 facing the water storage chamber 1041. The water body passing through the first flow channel 1013 can directly enter the water storage chamber 1041 for storage. Moreover, a plurality of first water outlets 1042-4 are provided at the support member 104, and each first water outlet 1042-4 is communicated with the second flow channel 1014. The water in the water storage chamber 1041 passes through the first water outlet 1042-4 and enters the second flow channel 1014.

Referring to FIG. 1, it may be further understood that the inner shell 102 can extend to the bottom wall of the outer shell assembly 101, and there is a certain water-pass gap between the inner shell 102 and the inner wall surface of the outer shell assembly 101, which is equivalent to that the water storage chamber 1041 is separated from the first flow channel 1013. The water body in the second flow channel 1014 continues to enter the water-pass gap, and enters the water storage chamber 1041 from the water-pass gap. This is equivalent to that a water inlet path is extended. The water first entering the water storage chamber 1041 flows out from the first water outlet 1042-4 of the water storage chamber 1041, which is beneficial to that the water first entering a water purification module is filtered first and then flows out from the water purification module, thereby preventing the retention of stale water.

Openings may be opened at a bottom end of the inner shell 102 close to the outer shell assembly 101, that is, a plurality of openings may be opened at a side wall or an end surface of the inner shell 102 to form the first water inlet 1042-3 of the water storage chamber 1041.

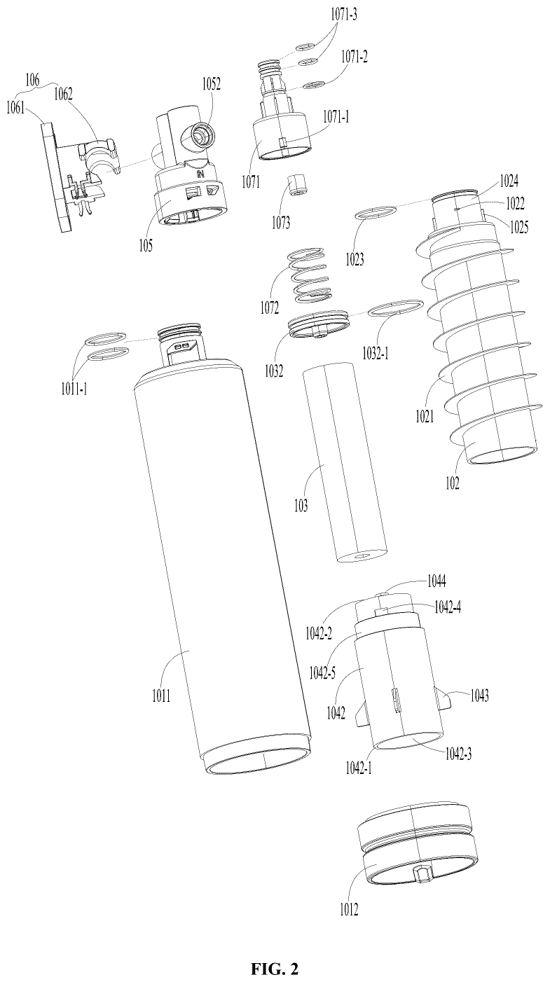

Referring to FIG. 2, it may be understood that the structural shape of the support member 104 is adapted to the structural shapes of the filter element 103, the inner shell 102, etc., and may be a cylindrical structure for axially supporting the filter clement 103 and blocking an end of the filter element 103. An interior of the support member 104 is a hollow structure to form a water flow channel and a water storage space.

The support member 104 includes a support member body 1042 and a limit block 1043. The limit block 1043 is provided at an outer wall of the support member body 1042, which is equivalent to a connected protruded lug of the support member body 1042, and is suitable for abutting against or lapping on the inner wall surface of the outer shell assembly 101 to fix the support member body 1042.

The support member body 1042 has a first end 1042-1 and a second end 1042-2. The first end 1042-1 is formed with a first water inlet 1042-3. The first water inlet 1042-3 is communicated with the first flow channel 1013, so that the water in the first flow channel 1013 enters the water storage chamber 1041 through the first water inlet 1042-3. The second end 1042-2 is adapted to abut against the filter element 103, and is used to block an end of the filter element 103, so that the water in the water storage chamber 1041 is filtered by the filter element 103 and then enters the third flow channel 1031 inside the filter element 103.

An outer wall surface of the support member body 1042 may be aligned with the outer wall surface of the inner shell 102, so that there is a water-pass gap between the support member body 1042 and the inner shell 102. The water body in the second flow channel 1014 continues to enter the water-pass gap, and enters the first water inlet 1042-3 of the water storage chamber 1041 from the water-pass gap. This is equivalent to that a water inlet path is extended. The water first entering the water storage chamber 1041 first flows out from the first water outlet 1042-4 of the water storage chamber 1041, which is beneficial to that the water first entering a water purification module is filtered first and then flows out from the water purification module, thereby preventing the retention of stale water.

Referring to FIG. 1 and FIG. 2, it may be further understood that the second end 1042-2 of the support member body 1042 is provided with a first block member 1044. The first block member 1044 is adapted to abut against the filter element 103, and is used to block an end of the filter element 103, so that the water in the water storage chamber 1041 is filtered by the filter element 103 and then enters the third flow channel 1031 inside the filter element 103. The first block member 1044 may be provided independently from the support member 104, which may be fixedly connected or detachably connected to the second end 1042-2 of the support member 104.

As shown in FIG. 2, the support member body 1042 and the first block member 1044 may also be integrally formed, so that a side of the first block member 1044 facing the filter element 103 is provided with a block groove 1044-1. The filter element 103 may be embedded in the block groove 1044-1, which is equivalent to that an outer wall surface of the filter element 103 and an inner side wall of the block groove 1044-1 are in interference fit to form a seal effect. A seal member may also be provided between the block groove 1044-1 and the filter element 103, so that the filter element 103 is connected with and at least partially seals the block groove 1044-1.

A protrusion is provided inside the block groove 1044-1. After the filter element 103 is embedded in the block groove 1044-1, the protrude portion 1044-2 extends into the third flow channel 1031, which makes the seal effect of the first block member 1044 better, and avoid the water leakage at an end portion of the filter element 103.

Referring to FIG. 1 and FIG. 2, it may be understood that the outer side wall of the support member body 1042 is provided with a limit portion 1042-5, and the inner shell 102 abuts against the limit portion 1042-5 to limit the inner shell 102 from continuing to move close the bottom wall of outer shell assembly 101, and play an axial support role for the inner shell 102.

A first water outlet 1042-4 is provided at a side wall between the limit portion 1042-5 and the second end 1042-2 of the support member body 1042, and the first water outlet 1042-4 is communicated with the second flow channel 1014. This is equivalent to that a water outlet direction is inclined toward the side wall of the support member body 1042, so that the water coming out from the water storage chamber 1041 flows into the second flow channel 1014 more smoothly.

Therefore, the support member 104 is not only suitable for axial support of the filter element 103, but also suitable for axial support of the inner shell 102, thereby reducing the number of components and parts of the water purification assembly 100, and further simplifying its structure.

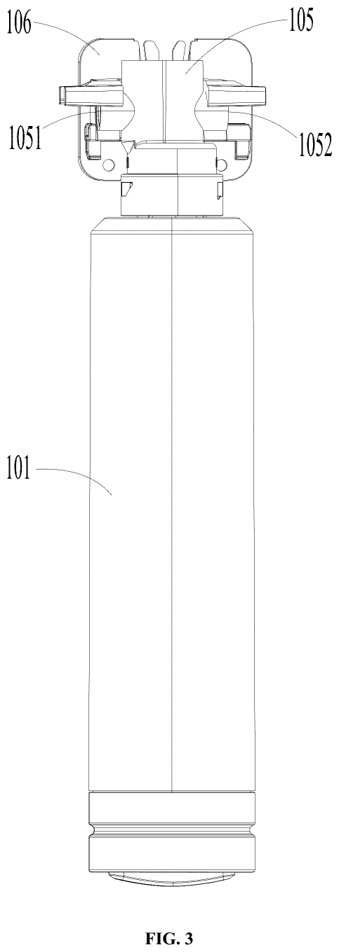

Referring to FIG. 1, FIG. 2 and FIG. 3, it may be understood that the outer shell assembly 101 includes a first outer shell 1011 and a second outer shell 1012. The first outer shell 1011 and the second outer shell 1012 are detachably connected, that is, the first outer shell 1011 and the second outer shell 1012 may be in interference fit, may be clamped, or may be threadedly connected, etc., while ensuring the sealing between the first outer shell 1011 and the second outer shell 1012.

By detachably connecting the first outer shell 1011 and the second outer shell 1012, internal parts of the water purification assembly 100 may be replaced by disassembling the first outer shell 1011 and the second outer shell 1012, thus facilitating the maintenance and replacement of the water purification assembly 100.

Referring to FIG. 1, it may be understood that the radial distance of the first flow channel 1013 is greater than the radial distance of the second flow channel 1014, thereby ensuring a large water inlet and a small water outlet, so that the water storage chamber 1041 is in a state of dynamic balance.

Radial distances may be understood as a distance between an inner wall surface of the first outer shell 1011 and an outer wall surface of the inner shell 102, and a distance between the outer wall surface of the filter element 103 and the inner wall surface of the inner shell 102.

Referring to FIG. 1 and FIG. 2, it may be understood that in order to extend a flow path of the water body in the water purification assembly 100, a flow guide portion 1021 is provided between the inner shell 102 and the first outer shell 1011, and the flow guide portion 1021 may extend along a central axis of the inner shell 102 to form a spiral structure. The first flow channel 1013 is provided as a spiral flow channel, one end of the spiral flow channel is communicated with the main water inlet 1051, and another end of the spiral flow channel is communicated with the first water inlet 1042-3 of the water storage chamber 1041.

By providing the flow guide portion 1021 between the first outer shell 1011 and the inner shell 102, the first flow channel 1013 forms a spiral flow channel. When the water is input from the main water inlet 1051, the water flows to the water storage chamber 1041 along an extend direction of the spiral flow channel. This is equivalent to the spiral flow channel extending the flow path of the water body, so that the water body first flowing into the water purification assembly 100 first flows out of the water purification assembly 100, that is, first-in-first-out of the water body is realized, which can effectively prevent the accumulation of stale water, and prevent a phenomenon of water mixing from occurring.

Furthermore, by extending the flow path of the water body, a heat exchange area between the water body in the spiral flow channel and the outside is increased, thereby accelerating the cooling of the water body in the water purification assembly 100, so that the cooling effect of the water body is better. Meanwhile, the spiral flow channel can effectively prevent backflow along the spiral flow channel due to external factors during the water flow procedure.

Referring to FIG. 1 and FIG. 2, it may be further understood that the flow guide portion 1021 may be provided at the inner wall surface of the first outer shell 1011 or on the outer wall surface of the inner shell 102, or the flow guide portion 1021 may be sandwiched between the inner wall surface of the first outer shell 1011 and the outer wall surface of the inner shell 102.

That is, the flow guide portion 1021 is provided inside at least one of the first flow channel 1013 and the second flow channel 1014, which may be understood to mean that the flow guide portion 1021 is provided inside the first flow channel 1013 or the second flow channel 1014, or the flow guide portion 1021 may be provided inside both the first flow channel 1013 and the second flow channel 1014, and the flow guide portion 1021 extends along the central axis of the inner shell 102 to form a spiral structure.

An axial length of the flow guide portion 1021 extending relative to the central axis of the inner shell 102 is less than an axial length of the inner shell 102. For example, the axial length of the flow guide portion 1021 extending relative to the central axis of the inner shell 102 is equal to ½, ⅔, etc. of the axial length of the inner shell 102. This may also be understood as providing the flow guide portion 1021 at a part of the outer wall surface of the inner shell 102.

In order to further enhance an anti-mixing effect, the flow guide portion 1021 may be provided at the entire outer wall of the inner shell 102, that is, the axial length of the flow guide portion 1021 extending relative to the central axis of the inner shell 102 is equal to the axial length of the inner shell 102.

It should be noted that the filter element 103 may be an activated carbon rod filter element 103 or a filter element 103 rolled by a reverse osmosis membrane known in the art. Any purification core material that can achieve water filtration is available.

Referring to FIG. 1 to FIG. 5, it may be understood that the water purification assembly 100 further includes a socket assembly 105. The socket assembly 105 includes a socket main body and a valve core assembly 1056 provided inside the socket main body.

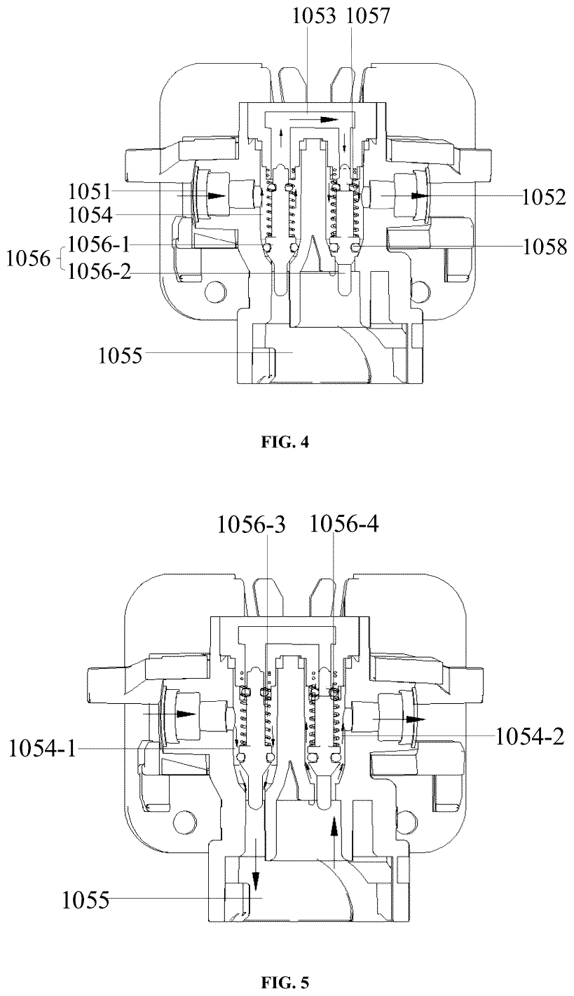

As shown in FIG. 3, FIG. 4 and FIG. 5, the socket main body is provided with a main water inlet 1051 and a main water outlet 1052. In addition, the socket main body is a hollow shell structure, and a bypass chamber 1053, a dispensing chamber 1054 and an operation chamber 1055 are provided inside the socket main body. The bypass chamber 1053 is communicated with the operation chamber 1055 through the dispensing chamber 1054. The socket assembly 105 is detachably connected to the water purification assembly 100 through the operation chamber 1055.

It should be noted that the main water inlet 1051 and the main water outlet 1052 do not limit a specific water flow direction. For example, the main water inlet 1051 may inlet or outlet water. Similarly, the main water outlet 1052 may outlet or inlet water. Specific arrangement may be selected based on actual use needs.

As shown in FIG. 4 and FIG. 5, it may be understood that the valve core assembly 1056 may be movably provided inside the dispensing chamber 1054, and is adapted to switch between a first position and a second position.

As shown in FIG. 4, in case that the valve core assembly 1056 is at the first position, the valve core assembly 1056 blocks the dispensing chamber 1054 and the operation chamber 1055, which is equivalent to that the dispensing chamber 1054 and the operation chamber 1055 are not communicated. The main water inlet 1051, the dispensing chamber 1054, the bypass chamber 1053 and the main water outlet 1052 are communicated with each other.

As shown in FIG. 5, in case that the valve core assembly 1056 is at the second position, the valve core assembly 1056 blocks the dispensing chamber 1054 and the bypass chamber 1053, which is equivalent to that the dispensing chamber 1054 and the bypass chamber 1053 are not communicated. The main water inlet 1051, the dispensing chamber 1054, the operation chamber 1055 and main water outlet 1052 are communicated with each other.

Referring to FIG. 4, it may be understood that the main water inlet 1051 may be communicated with an external water source through a water pipe, and the external water source may be tap water or well water, etc. The main water outlet 1052 is communicated with the water-use component 500 or the valve assembly 200 through a water pipe. The water-use component 500 may be a first ice maker 501, a second ice maker 502, a dispenser 503, etc. By controlling the position of the valve core assembly 1056 in the dispensing chamber 1054, the dispensing chamber 1054 is adjusted to be communicated with the bypass chamber 1053, then the main water inlet 1051 is communicated with the main water outlet 1052 through the dispensing chamber 1054 and the bypass chamber 1053, ensuring that the water path between the main water inlet 1051 and the main water outlet 1052 are communicated, to avoid water overflow when replacing the filter element 103.

Referring to FIG. 5, it may be understood that by controlling the position of the valve core assembly 1056 in the dispensing chamber 1054, the dispensing chamber 1054 and the operation chamber 1055 are adjusted to be communicated, so that the main water inlet 1051 is communicated with the main water outlet 1052 of the water purification assembly 100 through the dispensing chamber 1054 and the operation chamber 1055. Meanwhile, it is equivalent to that the water purification assembly 100 being in an operating state, that is, the external water source may enter from the main water inlet 1051, enter the water purification assembly 100 for filtering through the dispensing chamber 1054 and the operation chamber 1055, and flow out from the main water outlet 1052 after being filtered.

During usage, if the filter element 103 is to be replaced or repaired, as shown in FIG. 4, the water purification assembly 100 may be removed from the socket assembly 105. Meanwhile, the water purification assembly 100 is disconnected from the operation chamber 1055 of the socket assembly 105. In order to ensure the normal operation of the waterway system, the valve core assembly 1056 is moved to the first position, that is, the position shown in FIG. 4. The valve core assembly 1056 blocks the dispensing chamber 1054 and the operation chamber 1055, and the dispensing chamber 1054 and the bypass chamber 1053 are used to communicate the main water inlet 1051 with the main water outlet 1052. Therefore, the external water source enters the dispensing chamber 1054 through the main water inlet 1051, then enters the bypass chamber 1053 through the dispensing chamber 1054, and finally flows out from the main water outlet 1052. The water path between the main water inlet 1051 and the main water outlet 1052 is communicated, which prevents the water body form overflowing when replacing the filter element 103, thereby improving element replacement experience of the user.

When the water purification assembly 100 is assembled at the socket assembly 105, that is, the water purification assembly 100 is communicated with the operation chamber 1055 of the socket assembly 105, and the valve core assembly 1056 is moved to the second position, that is, the position shown in FIG. 5. The valve core assembly 1056 blocks the dispensing chamber 1054 and the bypass chamber 1053, and the dispensing chamber 1054 and the operation chamber 1055 are used to communicate the main water inlet 1051 with the main water outlet 1052. Therefore, the external water source enters the dispensing chamber 1054 through the main water inlet 1051, and then the water body enters the water purification assembly 100 through the operation chamber 1055 for filtering, and flows out from the main water outlet 1052 after being filtered.

In some embodiments of the present application, by providing the socket assembly 105 composed of the socket main body and the valve core assembly 1056 provided inside the socket main body at the water purification assembly 100, the bypass chamber 1053, the dispensing chamber 1054 and the operation chamber 1055 are provided inside the socket main body, and the bypass chamber 1053 is communicated with the operation chamber 1055 through the dispensing chamber 1054. The socket assembly is detachably connected to the water purification assembly 100 through the operation chamber 1055. The valve core assembly 1056 may be movably provided inside the dispensing chamber 1054, and may be switched between the first position and the second position. In case that the valve core assembly 1056 is at the first position, the valve core assembly 1056 blocks the dispensing chamber 1054 and the operation chamber 1055, and the dispensing chamber 1054 and the bypass chamber 1053 are used to communicate the main water inlet 1051 with the main water outlet 1052. During the replacing of the filter element 103, the waterway may be ensured to be smooth and would not affect the use of the user, thereby improving the user experience.

Referring to FIG. 4 and FIG. 5, it may be understood that the dispensing chamber 1054 includes a first dispensing chamber body 1054-1 and a second dispensing chamber body 1054-2 provided in parallel. The first dispensing chamber body 1054-1 is communicated with the main water inlet 1051, the second dispensing chamber body 1054-2 is communicated with the main water outlet 1052, one end of the bypass chamber 1053 is communicated with the operation chamber 1055 through the first dispensing chamber body 1054-1, and another end of the bypass chamber 1053 is communicated with the operation chamber 1055 through the second dispensing chamber body 1054-2.

In case that the valve core assembly 1056 moves to the first position, the valve core assembly 1056 may simultaneously block the first dispensing chamber body 1054-1 and the operation chamber 1055, as well as the second dispensing chamber body 1054-2 and the operation chamber 1055, thereby allowing the main water inlet 1051 communicate with the main water outlet 1052 through the first dispensing chamber body 1054-1, the bypass chamber 1053 and the second dispensing chamber body 1054-2.

In case that the valve core assembly 1056 moves to the second position, the valve core assembly 1056 may simultaneously block the first dispensing chamber body 1054-1 and the bypass chamber 1053, as well as the second dispensing chamber body 1054-2 and the bypass chamber 1053, so that the main water inlet 1051 is communicated with the main water outlet 1052 through the first dispensing chamber body 1054-1, the operation chamber 1055 and the second dispensing chamber body 1054-2.

Referring to FIG. 4 and FIG. 5, it may be understood that the valve core assembly 1056 includes a first eject rod 1056-1 and a second eject rod 1056-2. The first eject rod 1056-1 is movably provided inside the first dispensing chamber body 1054-1, and is used to control dispensing of the water body in the first dispensing chamber body 1054-1. The second eject rod 1056-2 is movably provided inside the second dispensing chamber body 1054-2, and is used to control dispensing of the water body in the second dispensing chamber body 1054-2.

At least part of the first eject rod 1056-1 and the second eject rod 1056-2 extends into the operation chamber 1055. Since the water purification assembly 100 is connected to the socket assembly 105 through the operation chamber 1055, that is, part of the water purification assembly 100 is provided inside the operation chamber 1055.

When the water purification assembly 100 is mounted at the socket assembly 105, the water purification assembly 100 extends into the operation chamber 1055, contacts with the first eject rod 1056-1 and the second eject rod 1056-2, and presses against the first eject rod 1056-1 and the second eject rod 1056-2 to achieve a squeeze effect, thereby causing position change of the first eject rod 1056-1 in the first dispensing chamber body 1054-1, and causing position change of the second eject rod 1056-2 in the second dispensing chamber body 1054-2 simultaneously, so that the first eject rod 1056-1 and the second eject rod 1056-2 move to the second position. The first eject rod 1056-1 blocks the first dispensing chamber 1054-1 and the bypass chamber 1053, and the second eject rod 1056-2 blocks the second dispensing chamber body 1054-2 and the bypass chamber 1053, so that the main water inlet 1051 communicates with the main water outlet 1052 through the first dispensing chamber body 1054-1, the operation chamber 1055 and the second dispensing chamber body 1054-2.

The first dispensing chamber body 1054-1 may be either a water inlet chamber or a water outlet chamber. Correspondingly, the second dispensing chamber body 1054-2 may be either a water outlet chamber or a water inlet chamber. Moreover, water inlet and outlet directions of the first dispensing chamber body 1054-1 and the second dispensing chamber body 1054-2 correspond to water inlet and outlet directions of the first flow channel 1013, the second flow channel 1014 and the third flow channel 1031.

Referring to FIG. 4 and FIG. 5, it may be understood that when the first dispensing chamber body 1054-1 is taken as the water inlet chamber and the second dispensing chamber body 1054-2 is taken as the water outlet chamber, the external water source enters the first dispensing chamber body 1054-1 through the main water inlet 1051, and enters the operation chamber 1055 through the first dispensing chamber body 1054-1. The water body then enters the water purification assembly 100 through the operation chamber 1055 for filtration. The filtered water body enters the second dispensing chamber body 1054-2 through the operation chamber 1055, and finally flows out from the main water outlet 1052.

It should be noted that both the first eject rod 1056-1 and the second eject rod 1056-2 can achieve a block effect between two adjacent chambers through a variable diameter design. For example, when the position of the first eject rod 1056-1 in the first dispensing chamber body 1054-1 changes, a diameter of the first eject rod 1056-1 near two ends is greater than a diameter at other positions, so that the first eject rod 1056-1 may block connect positions between the first dispensing chamber body 1054-1 and the bypass chamber 1053 and the operation chamber 1055, thereby blocking the first dispensing chamber body 1054-1 from communicating with the bypass chamber 1053, or blocking the first dispensing chamber body 1054-1 from communicating with the operation chamber 1055.

The second eject rod 1056-2 achieving a block effect between the second dispensing chamber body 1054-2 and the adjacent bypass chamber 1053 or the operation chamber 1055 through a variable diameter design, which is the same as the variable diameter design of the first eject rod 1056-1 mentioned above, and is not repeated here.

Referring to FIG. 4 and FIG. 5, it may be understood that the socket assembly 105 may further include a first clastic member 1056-3 and a second elastic member 1056-4. The first clastic member 1056-3 is sleeved at the first eject rod 1056-1, and an end of the first clastic member 1056-3 may be connected to the first eject rod 1056-1, and other two ends of the first elastic member 1056-3 may be connected to a wall surface of the first dispensing chamber body 1054-1.

During the mounting procedure, the first elastic member 1056-3 may be sleeved as a whole on an outer surface of the first eject rod 1056-1. A top end of the first elastic member 1056-3 may be connected to an inner wall surface of the first dispensing chamber body 1054-1, and a bottom end of the first elastic member 1056-3 may be connected to a step of the first eject rod 1056-1. The first elastic member 1056-3 may undergo elastic deformation or restore elastic deformation during the up and down movement of the first eject rod 1056-1.

The second elastic member 1056-4 is sleeved at the second eject rod 1056-2. An end of the second elastic member 1056-4 may be connected to the second eject rod 1056-2, and other two ends of the second elastic member 1056-4 may be connected to a wall surface of the second dispensing chamber body 1054-2.

During the mounting procedure, the second elastic member 1056-4 may be mounted in the same mode as the first elastic member 1056-3, that is, the second elastic member 1056-4 is sleeved at the second eject rod 1056-2 as a whole, and a top end of the second elastic member 1056-4 is connected to an inner wall surface of the second dispensing chamber body 1054-2, and a bottom end of the second elastic member 1056-4 is connected to a step of the second eject rod 1056-2.

The first elastic member 1056-3 and the second elastic member 1056-4 may both be springs, or other elastic elements that may be elastically deformed under an action of external force and may restore the clastic deformation by themselves.

As shown in FIG. 4, when the water purification assembly 100 is removed from the socket assembly 105, that is, the water purification assembly 100 is separated from the socket assembly 105, the water purification assembly 100 is disconnected from the operation chamber 1055, and the valve core component 1056 is located at the first position. The water purification assembly 100 is separated from the first eject rod 1056-1 and the second eject rod 1056-2 respectively, the first eject rod 1056-1 releases the squeeze effect on the first elastic member 1056-3, and the second eject rod 1056-2 releases the squeeze effect on the second clastic member 1056-4. Both the first elastic member 1056-3 and the second elastic member 1056-4 restore elastic deformation, that is, they are transformed from a compressed state to a free state.

The first elastic member 1056-3 drives the first eject rod 1056-1 to move toward a position of the operation chamber 1055, so that the first eject rod 1056-1 is stuck at a connection position between the first dispensing chamber body 1054-1 and the operation chamber 1055, and the water body flow path between the first dispensing chamber body 1054-1 and the operation chamber 1055 is blocked through the first eject rod 1056-1. Meanwhile, it is equivalent to that the first eject rod 1056-1 is away from the connection position between the first dispensing chamber body 1054-1 and the bypass chamber 1053, and the first eject rod 1056-1 releases the block effect between the first dispensing chamber body 1054-1 and the bypass chamber 1053, so that the water body flow path between the first dispensing chamber body 1054-1 and the bypass chamber 1053 is conducted.

Correspondingly, the second elastic member 1056-4 drives the second eject rod 1056-2 to move toward the position of the operation chamber 1055, so that the second eject rod 1056-2 is stuck at the connection position between the second dispensing chamber body 1054-2 and the operation chamber 1055, and the water body flow path between the second dispensing chamber body 1054-2 and the operation chamber 1055 is blocked through the second eject rod 1056-2. Meanwhile, it is equivalent to that the second eject rod 1056-2 is away from the connection position between the second dispensing chamber body 1054-2 and the bypass chamber 1053, and the second eject rod 1056-2 releases the block effect between the second dispensing chamber body 1054-2 and the bypass chamber 1053, so that the water body flow path between the second dispensing chamber body 1054-2 and the bypass chamber 1053 is conducted.

As shown in FIG. 5, when the water purification assembly 100 is mounted at the socket assembly 105, that is, the water purification assembly 100 is connected inside the operation chamber 1055, the valve core component 1056 is at the second position, and the water purification assembly 100 has a squeeze effect on the first eject rod 1056-1 and the second eject rod 1056-2. The first eject rod 1056-1 and the second eject rod 1056-2 both move toward the position where the bypass chamber 1053 is located. The first elastic member 1056-3 and the second elastic member 1056-4 are elastically deformed under pressure, that is, they are transformed from a free state to a compressed state.

The first eject rod 1056-1 is stuck at a connection position between the first dispensing chamber body 1054-1 and the bypass chamber 1053, and the water body flow path between the first dispensing chamber body 1054-1 and the bypass chamber 1053 is blocked through the first eject rod 1056-1. It is equivalent to that the first eject rod 1056-1 is away from a connection position between the first dispensing chamber body 1054-1 and the operation chamber 1055, and the block effect between the first dispensing chamber body 1054-1 and the operation chamber 1055 is released, so that the water body flow path between the first dispensing chamber body 1054-1 and the operation chamber 1055 is conducted.

Correspondingly, the second eject rod 1056-2 is stuck at a connection position between the second dispensing chamber body 1054-2 and the bypass chamber 1053, and the water body flow path between the second dispensing chamber body 1054-2 and the bypass chamber 1053 is blocked through the second eject rod 1056-2. It is equivalent to that the second eject rod 1056-2 is away from the connection position between the second dispensing chamber body 1054-2 and the operation chamber 1055, and the block effect between the second dispensing chamber body 1054-2 and the operation chamber 1055 is released, so that the water body flow path between the second dispensing chamber body 1054-2 and the operation chamber 1055 is conducted.

Referring to FIG. 4 and FIG. 5, in order to ensure that the valve core assembly 1056 has a good block effect, the socket assembly 105 further includes a fourth seal ring 1057 and a fifth seal ring 1058. At least one fourth seal ring 1057 is sleeved at the first eject rod 1056-1 near the operation chamber 1055, and at least one fourth seal ring 1057 is sleeved at the second eject rod 1056-2 near the operation chamber 1055.

At least one fifth seal ring 1058 is sleeved at the first eject rod 1056-1 near the bypass chamber 1053, and at least one fifth seal ring 1058 is sleeved at the second eject rod 1056-2 near the bypass chamber 1053.

In case that the valve core assembly 1056 is at the first position, the first eject rod 1056-1 drives the fourth seal ring 1057 to block the water body flow path between the first dispensing chamber body 1054-1 and the operation chamber 1055, and the second eject rod 1056-2 also drives the fourth seal ring 1057 to block the water body flow path between the second dispensing chamber body 1054-2 and the operation chamber 1055.

In case that the valve core assembly 1056 is at the second position, the first eject rod 1056-1 drives the fifth seal ring 1058 to block the water body flow path between the first dispensing chamber body 1054-1 and the bypass chamber 1053, and the second eject rod 1056-2 drives the fifth seal ring 1058 to block the water body flow path between the second dispensing chamber body 1054-2 and the bypass chamber 1053.

Referring to FIG. 1, FIG. 2, FIG. 4 and FIG. 5, it may be understood that the socket assembly further includes: a fixed seat 106. The fixed seat 106 is used for mounting the water purification assembly 100 to a desired position, and the fixed seat 106 is detachably connected to the socket assembly 105.

The socket assembly 105 and the fixed seat 106 may be detachably assembled by means of a clamped connection, or other assembly modes may be adopted, such as a fixed connection, etc. The socket assembly 105 and the fixed seat 106 may also be integrally formed, so that the socket assembly 105 and the fixed seat 106 form an integral structure.

Referring to FIG. 2, it may be understood that the fixed seat 106 includes a first seat body 1061 and a second seat body 1062. The second seat body 1062 is connected to a side of the first seat body 1061, and the second seat body 1062 is provided with a position suitable for mounting the socket main body. The socket main body is connected to the fixed seat 106 through the second seat body 1062.

During usage, the fixed seat 106 may be fixed at an external device, the second seat body 1062 is connected to a front of the fixed seat 106, and a back of the fixed seat 106 is provided with bolt holes for connecting to the external device. To ensure the connect effect, the second seat body 1062 is provided with a pipe seat for clamping the main water inlet 1051, and a pipe seat for clamping the main water outlet 1052. The pipe seat for clamping the main water inlet 1051 is stuck at a pipe outer wall of the main water inlet 1051, and the pipe seat for clamping the main water outlet 1052 is stuck on a pipe outer wall of the main water outlet 1052, thereby ensuring the stability of the entire seat body.

It should be noted that the main water inlet 1051 may also be provided at the first outer shell 1011, and the main water outlet 1052 may be provided at the inner shell 102. That is, the main water inlet 1051 is provided at an end of the first outer shell 1011, and the main water inlet 1051 is communicated with the first flow channel 1013. Meanwhile, the main water outlet 1052 is provided at an end of the inner shell 102, and the main water outlet 1052 is communicated with the third flow channel 1031.

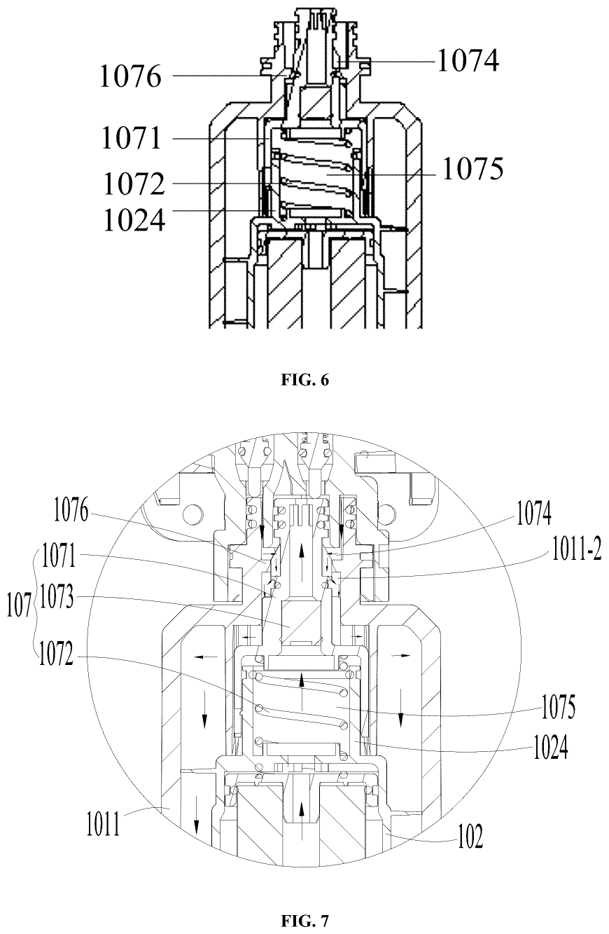

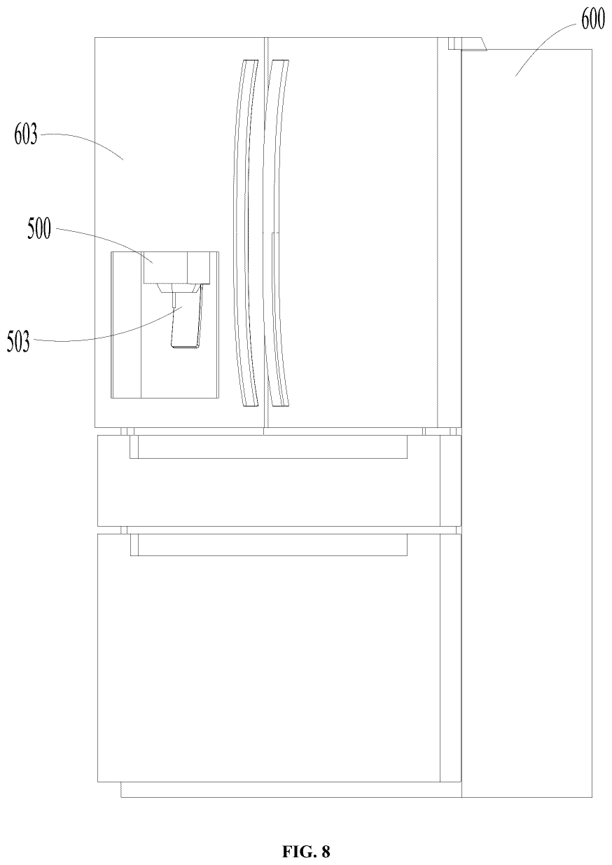

Referring to FIG. 1, FIG. 2, FIG. 6 and FIG. 7, it may be understood that in order to prevent the water inside the water purification assembly 100 from flowing out when the filter element 103 is pulled out or replaced, the water purification assembly 100 may also include a water-stop assembly 107. A water-stop chamber 1011-2 is provided inside the first outer shell 1011 and located at a water outlet side of the filter element 103. The water-stop assembly 107 is movably provided at the water-stop chamber 1011-2, that is, the water-stop assembly 107 may move in the water-stop chamber 1011-2 and is suitable for switching between the first position and the second position.

Referring to FIG. 6 and FIG. 7, it may be understood that a first passage 1074 is provided at an outside of the water-stop assembly 107, and it may also be understood that the first passage 1074 is provided between the first outer shell 1011 and the water-stop assembly 107, which is equivalent to that after the water-stop assembly 107 is provided inside the water-stop chamber 1011-2, there is a water-pass gap between the water-stop assembly 107 and a chamber wall of the water-stop chamber 1011-2. The water-pass gap may be conducted and blocked as the water-stop assembly 107 moves in the water-stop chamber 1011-2.

As shown in FIG. 6 and FIG. 7, a second passage 1075 is provided inside the water-stop assembly 107, and a check valve 1073 is provided inside the second passage 1075 for realizing on-off according to a pressure difference. The check valve 1073 may not only be used to limit a flow direction of the water body, but also may realize the conducting-blocking of a waterway according to the pressure difference on both sides of the check valve 1073.

As shown in FIG. 6, when the water-stop assembly 107 is at the first position, the water-stop assembly 107 may block the first passage 1074. The check valve 1073 determines that the pressure difference on both sides is small and blocks the waterway, that is, the check valve 1073 blocks the second passage 1075.

The water-stop assembly 107 is detachably connected to the socket assembly 105. When it is determined that the filter element 103 is to be pulled out or replaced, the water purification assembly 100 is removed from the socket assembly 105. The water-stop assembly 107 moves to an outside of the first outer shell 1011 to abut against the inner wall of the first outer shell 1011, that is, the water-stop assembly 107 abuts against the chamber wall of the water-stop chamber 1011-2, thereby blocking the first passage 1074, and the water body cannot flow through the first passage 1074. The check valve 1073 determines that the pressure difference on both sides is small, and the check valve 1073 further blocks the second passage 1075, so that the water body cannot flow through the second passage 1075, so as to achieve the water-stop function of the water-stop assembly 107.

As shown in FIG. 7, when the water-stop assembly 107 is at the second position, the water-stop assembly 107 may conduct the first passage 1074. The check valve 1073 determines that the pressure difference on both sides is large and conducts the waterway, that is, the check valve 1073 conducts the second passage 1075.

As shown in FIG. 7, the water purification assembly 100 is assembled at the socket assembly 105. The socket assembly 105 squeezes the water-stop assembly 107 to move the water-stop assembly 107 toward an inside of the first outer shell 1011. There is a water-pass gap between the water-stop assembly 107 and the first outer shell 1011, which is equivalent to that the water-stop assembly 107 conducts the first passage 1074, and the water body may flow through the first passage 1074. The check valve 1073 determines that the pressure difference on both sides is large, and the check valve 1073 further conducts the second passage 1075, so that the water body may flow through the second passage 1075, so as to achieve a normal operate state of the water-stop assembly 107.

By detachably connecting the water-stop assembly 107 and the water purification assembly 100, when it is determined that the filter element 103 is to be pulled out or replaced, the water purification assembly 100 is disassembled from the socket assembly 105. Since the water-stop assembly 107 is provided at the water outlet side of the water purification assembly 100, the water-stop assembly 107 may block the water in the water purification assembly 100 from continuing to flow out, thereby effectively preventing dirty water from overflowing when the user plugs in and out the filter element 103, thereby improving element replacement experience of the user.

Referring to FIG. 2, FIG. 6 and FIG. 7, it may be understood that the water-stop assembly 107 may include a water-stop shell body 1071. The water-stop shell body 1071 is a shell-like structure, and an accommodating chamber is provided inside the water-stop shell body 1071. The inner shell 102 locating at the water outlet side of the filter element 103 extends outward to form a fixed portion 1024, and the shape of the water-stop shell body 1071 is adapted to the shape of the fixed portion 1024. The water-stop shell body 1071 may be sleeved at an outside of the fixed portion 1024, or the water-stop shell body 1071 may be sleeved at an inside of the fixed portion 1024, so that the water-stop shell body 1071 moves along an outer side wall or an inner side wall of the fixed portion 1024.

Referring to FIG. 2, FIG. 6 and FIG. 7, it may be understood that an elastic member 1072 is provided inside the water-stop shell body 1071, one end of the elastic member 1072 is connected to a chamber wall of the accommodating chamber, and another end of the elastic member 1072 is connected to the fixed portion 1024. When the elastic member 1072 is elastically deformed under pressure, the fixed portion 1024 may be completely accommodated in the accommodating chamber. When the clastic member 1072 restores elastic deformation, the water-stop shell body 1071 is subjected to an elastic restoring force of the elastic member 1072, and moves in the water-stop chamber 1011-2, so that the fixed portion 1024 is exposed from the accommodating chamber. The water-stop shell body 1071 is movably provided at the fixed portion 1024 through the elastic member 1072, that is, the water-stop shell body 1071 may move relative to the fixed portion 1024. The clastic member 1072 may be a spring.

It should be understood that the second passage 1075 may be formed inside the water-stop shell body 1071, and the second passage 1075 may also be partially formed inside the fixed portion 1024 and partially formed inside the water-stop shell body 1071. The second passage 1075 may also be provided inside the water-stop shell body 1071 or the fixed portion 1024.

As shown in FIG. 6, when it is determined that the filter element 103 is to be pulled out or replaced, the water-stop assembly 107 is disassembled from the socket assembly 105, which is equivalent to canceling the squeeze effect of the socket assembly 105 on the water-stop shell body 1071. The elastic member 1072 restores elastic deformation, drives the water-stop shell body 1071 to move along an axial direction of the fixed portion 1024 until the water-stop shell body 1071 abuts against the inner wall of the first outer shell 1011, and the water-pass gap formed with the first outer shell 1011 disappears. The water-stop assembly 107 is at the first position, and blocks the first passage 1074. The check valve 1073 determines that the pressure difference on both sides is small, and blocks the second passage 1075, so as to achieve the water-stop function of the water-stop assembly 107.

As shown in FIG. 7, when the water-stop assembly 107 is mounted at the socket assembly 105, it is equivalent to the socket assembly 105 exerting a squeeze effect on the water-stop shell body 1071. The position of the fixed portion 1024 remains unchanged, the elastic member 1072 is elastically deformed under pressure, and the water-stop shell body 1071 moves along the axial direction of the fixed portion 1024, and a water-pass gap is formed with the inner wall of the first outer shell 1011. The water-stop assembly 107 is located at the second position, and conducts the first passage 1074. The check valve 1073 determines that the pressure difference on both sides is large, and controls the second passage 1075 to be conducted, so that the water purification assembly 100 is in a normal operate state.

Referring to FIG. 2, FIG. 6 and FIG. 7, it may be understood that in order to make the water-stop effect of the water-stop assembly 107 better, the water-stop assembly 107 may further include a sixth seal ring 1071-2. The sixth seal ring 1071-2 is sleeved at the water-stop shell body 1071, and may move up and down in the water-stop chamber 1011-2 with the movement of the water-stop shell body 1071. The sixth seal ring 1071-2 may be a rubber seal ring.

As shown in FIG. 6, when it is determined that the filter element 103 is to be pulled out or replaced, the water-stop assembly 107 is disassembled from the socket assembly 105, which is equivalent to canceling the squeeze effect of the socket assembly 105 on the water-stop shell body 1071. The elastic member 1072 restores elastic deformation, drives the water-stop shell body 1071 to move along the axial direction of the fixed portion 1024. The sixth seal ring 1071-2 moves with the water-stop shell body 1071 to form a seal surface with an inner wall of the water-stop chamber 1011-2 to block the first passage 1074. The check valve 1073 determines that the pressure difference on both sides is small, and blocks the second passage 1075, so as to achieve the water-stop function of the water-stop assembly 107.

As shown in FIG. 7, when the water-stop assembly 107 is mounted at the socket assembly 105, it is equivalent to the socket assembly 105 exerting a squeeze effect on the water-stop shell body 1071. The position of the fixed portion 1024 remains unchanged, the elastic member 1072 is elastically deformed under pressure. The water-stop shell body 1071 moves along the axial direction of the fixed portion 1024, and the sixth seal ring 1071-2 moves with the water-stop shell body 1071, and the seal surface formed with the inner wall of the water-stop chamber 1011-2 is released to conduct the first passage 1074. The check valve 1073 determines that the pressure difference on both sides is large, and controls the second passage 1075 to be conducted, so that the water purification assembly 100 is in a normal operate state.

Referring to FIG. 2, FIG. 6 and FIG. 7, it may be understood that in order to make the water-stop effect of the water-stop assembly 107 better, a seal protrusion 1076 may be provided at an inner side wall of the first outer shell 1011. The seal protrusion 1076 is located at an inner side wall of the water-stop chamber 1011-2, and is used to cooperate with the sixth seal ring 1071-2 to achieve the water-stop function. The seal protrusion 1076 may be provided at partial inner side wall of the first outer shell 1011, or it may be provided as an annular structure along a radial direction of the first outer shell 1011.

As shown in FIG. 6, when it is determined that the filter element 103 is to be pulled out or replaced, the water-stop assembly 107 is disassembled from the socket assembly 105, which is equivalent to canceling the squeeze effect of the socket assembly 105 on the water-stop shell body 1071. The elastic member 1072 restores elastic deformation, drives the water-stop shell body 1071 to move along the axial direction of the fixed portion 1024. The sixth seal ring 1071-2 moves with the water-stop shell body 1071, and abuts against the seal protrusion 1076 to form a seal surface to block the first passage 1074. The check valve 1073 determines that the pressure difference on both sides is small, and blocks the second passage 1075, so as to achieve the water-stop function of the water-stop assembly 107.

On the contrary, as shown in FIG. 7, when the water-stop assembly 107 is mounted at the socket assembly 105, it is equivalent to the socket assembly 105 exerting a squeeze effect on the water-stop shell body 1071. The elastic member 1072 is elastically deformed under pressure, the water-stop shell body 1071 moves along the axial direction of the fixed portion 1024. The sixth seal ring 1071-2 moves with the water-stop shell body 1071, and the seal surface formed with the seal protrusion 1076 is released to conduct the first passage 1074. The check valve 1073 determines that the pressure difference on both sides is large, and controls the second passage 1075 to be conducted, so that the water purification assembly 100 is in a normal operate state.

Referring to FIG. 2, FIG. 6 and FIG. 7, it may be understood that the water-stop assembly 107 may further include at least one seventh seal ring 1071-3, that is, the water-stop assembly 107 includes one or two seventh seal rings 1071-3. The seventh seal ring 1071-3 is coaxially provided with the sixth seal ring 1071-2, and is also sleeved at the water-stop shell body 1071, and moves synchronously with the water-stop shell body 1071.

The seventh seal ring 1071-3 may be a rubber seal ring. The seventh seal ring 1071-3 is provided at an end of the water-stop shell body 1071 facing the socket assembly 105, so that the water-stop assembly 107 may ensure good seal effect between the water-stop shell body 1071 and the socket assembly 105 during the position switching procedure.

Referring to FIG. 2, FIG. 6 and FIG. 7, it may be understood that, during the position switching procedure of the water-stop assembly 107, in order to ensure a good seal effect between the water-stop shell body 1071 and the fixed portion 1024, the water-stop assembly 107 may further include a second seal ring 1023. The second seal ring 1023 is sleeved at the fixed portion 1024, and is located between the water-stop shell body 1071 and the fixed portion 1024. The second seal ring 1023 may be a rubber seal ring, and is used to ensure the sealing between the water-stop shell body 1071 and the fixed portion 1024 during the movement of the water-stop assembly 107.

Referring to FIG. 2, FIG. 6 and FIG. 7, it may be understood that in order to prevent the water-stop shell body 1071 from separating from the fixed portion 1024, a limit protrusion 1022 is provided at the fixed portion 1024, and a limit groove 1071-1 is provided at a position corresponding to the limit protrusion 1022 on the water-stop shell body 1071. The limit groove 1071-1 is slidably sleeved at the limit protrusion 1022, so that the water-stop shell body 1071 moves relative to the fixed portion 1024 within a stroke limited by the limit groove 1071-1, thereby preventing the water-stop shell body 1071 from separating from the fixed portion 1024.

In case that the water-stop assembly 107 is at the first position, the clastic member 1072 restores clastic deformation, drives the water-stop shell body 1071 to move along the axial direction of the fixed portion 1024, so that the limit protrusion 1022 abuts against one side of the limit groove 1071-1. In case that the water-stop assembly 107 is at the second position, the elastic member 1072 is compressed and elastically deformed, and the water-stop shell body 1071 moves along the axial direction of the fixed portion 1024, so that the limit protrusion 1022 abuts against another side of the limit groove 1071-1.

The cooperation between the limit protrusion 1022 and the limit groove 1071-1 may not only prevent the water-stop shell body 1071 from being separated from the fixed portion 1024, but also further ensure the water-stop function of the water-stop assembly 107. In case that the water-stop assembly 107 is located at the first position to block the first passage 1074, the check valve 1073 determines that the pressure difference on both sides is small, and blocks the second passage 1075, so as to achieve the water-stop function of the water-stop assembly 107. In case that the water-stop assembly 107 is located at the second position to conduct the first passage 1074, the check valve 1073 determines that the pressure difference on both sides is large, so as to conduct the second passage 1075.

Referring to FIG. 2, FIG. 6 and FIG. 7, it may be understood that in order to ensure that the water-stop assembly 107 can move along a set path, a guide structure may be provided between the water-stop assembly 107 and the fixed portion 1024. The guide structure may include a guide protrusion 1025 provided at the outer side wall of the fixed portion 1024, and a guide groove (not shown in the figure) provided at an inner side wall of the water-stop shell body 1071 corresponding to the position of the guide protrusion 1025. When the water-stop shell body 1071 moves along the outer side wall of the fixed portion 1024, the guide protrusion 1025 moves in the guide groove.

The positions and shapes of the guide groove and the guide protrusion 1025 may be adjusted based on actual use needs. The guide protrusion 1025 may be provided along the axial direction of the fixed portion 1024, so that the water-stop assembly 107 moves up and down along the axial direction of the fixed portion 1024.

It should be noted that the first passage 1074 may be provided as a water inlet channel or a water outlet channel. Similarly, the second passage 1075 may be provided as a water inlet channel or a water outlet channel. When the first passage 1074 and the second passage 1075 are used as water inlet channels or water outlet channels, they may correspond to the water inlet and outlet directions of the first flow channel 1013, the second flow channel 1014 and the third flow channel 1031.

Referring to FIG. 2, FIG. 6 and FIG. 7, when the first passage 1074 is a water inlet channel and the second passage 1075 is a water outlet channel, the first passage 1074 is communicated with the first flow channel 1013, and the second passage 1075 is communicated with the third flow channel 1031. The water-stop assembly 107 is assembled at the water purification assembly 100, and then the water purification assembly 100 assembled with the water-stop assembly 107 is assembled at the socket assembly 105. The water body enters the first passage 1074 from the main water inlet 1051, and then flows into the first flow channel 1013 from the first passage 1074. After entering the water storage chamber 1041 from the first flow channel 1013, the water body may be temporarily stored in the water storage chamber 1041. When the user uses water, part of the water body in the water storage chamber 1041 enters the second flow channel 1014, and then penetrates from the second flow channel 1014 to the filter element 103 for filtration. The water filtered by the filter element 103 flows out from the third flow channel 1031 inside the filter element 103, enters the second passage 1075, and flows out from the second passage 1075 to the main water outlet 1052.

It should be noted that during the assembly procedure of the water purification assembly 100, the first block member 1044, the second block member 1032 and the third seal ring 1032-1 may be respectively bonded and fixed to both ends of the filter element 103 by food-grade glue. The second seal ring 1023 is then assembled at the inner shell 102, and the inner shell 102 is sleeved at the outer side of the filter element 103 that has been encapsulated at both ends. After the sixth seal ring 1071-2 and the seventh seal ring 1071-3 are assembled at corresponding positions of the water-stop shell body 1071, the check valve 1073 and the elastic member 1072 are mounted inside the water-stop shell body 1071 to form the water-stop assembly 107.

The water-stop shell body 1071 is then clamped at the fixed portion 1024 through the cooperation of the limit groove 1071-1 and the limit protrusion 1022, so as to achieve the assembly of the water-stop shell body 1071 and the inner shell 102. Finally, the first outer shell 1011 is sleeved from a top of the inner shell 102, and the second outer shell 1012 is ejected against a bottom of the support member 104, to complete a butt-joint of the first outer shell 1011 and the second outer shell 1012, and then the first outer shell 1011 and the second outer shell 1012 are rotated and welded to complete the overall assembly of the water purification assembly 100.

The above one or more solutions of the water purification assembly 100 provided by some embodiments of the present application have at least one of the following effects.

By providing the water storage chamber 1041 for water storage in the water purification assembly 100, the water purification assembly 100 is more integrated, and the water purification assembly 100 not only has a purify function, but also has a water storage function. The water tank structure, which is provided independently from water purification assembly 100 in the related art, is replaced by the water storage chamber 1041, that is, the water tank is canceled, thereby simplifying a structural design of the waterway system and reducing space occupied by the waterway system. Meanwhile, connect pipes and connect joints between the water tank and the water purification assembly 100 are canceled, which effectively avoids structural leakage risks, thereby making a product more reliable and user experience better.

By improving the water purification assembly 100, the waterway system is streamlined. After replacing the water purification assembly 100, the water storage space in the entire waterway system may be replaced, further ensuring the safety of user water use.

By providing a spiral flow channel in the water purification assembly 100, when the water is input from the main water inlet 1051, the water flows to the water storage chamber 1041 along an extend direction of the spiral flow channel. This is equivalent to the spiral flow channel extending the flow path of the water body, so that the water body first flowing into the water purification assembly 100 first flows out of the water purification assembly 100, that is, first-in-first-out of the water body is realized, which can effectively prevent the accumulation of stale water, and prevent a phenomenon of water mixing from occurring.

By detachably connecting the water-stop assembly 107 and the water purification assembly 100, when it is determined that the filter element 103 is to be pulled out or replaced, the water purification assembly 100 is disassembled from the socket assembly 105. Since the water-stop assembly 107 is provided at the water outlet side of the water purification assembly 100, the water-stop assembly 107 may block the water in the water purification assembly 100 from continuing to overflow, thereby effectively preventing dirty water from overflowing when the user plugs in and out the filter element 103, thereby improving element replacement experience of the user.

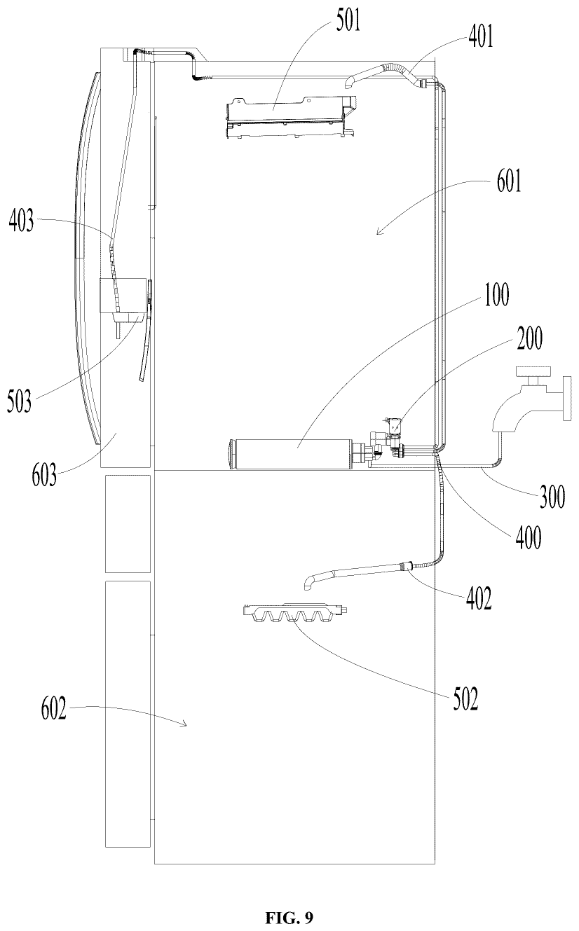

Referring to FIG. 8 and FIG. 9, the present application further provides a refrigeration device 600, including a refrigeration compartment and a water-use component 500, and the above-mentioned water purification assembly 100. The water purification assembly 100 is provided in the refrigeration compartment, and the main water outlet 1052 of the water purification assembly 100 is communicated with the water-use component 500.

In some embodiments of the present application, the refrigeration device 600 further includes a valve assembly 200. A liquid inlet of the valve assembly 200 is communicated with the main water outlet 1052 of the water purification assembly 100, and the liquid outlet of the valve assembly 200 is communicated with at least one water-use component 500.

In some embodiments of the present application, the water-use component 500 includes a first ice maker 501, a second ice maker 502 and a dispenser 503. The refrigeration compartment includes a refrigerator compartment 601 and a freezer compartment 602. The first ice maker 501 is provided at the refrigerator compartment 601, the second ice maker 502 is provided at the freezer compartment 602, and the dispenser 503 is provided at the door body 603 of the refrigeration device 600.

In some applications of the present application, as shown in FIG. 9, the water purification assembly 100 may be mounted in the refrigerator compartment 601, and the refrigeration device 600 further includes a plurality of water supply pipes. One end of a water supply pipe is used to communicate with the water supply system (tap water network), and another end of the water supply pipe extends into the refrigerator compartment 601 and communicates with the main water inlet 1051 of the water purification assembly 100. Since the water purification assembly 100 is provided inside the refrigerator compartment 601, in the low temperature environment of the refrigerator compartment 601, the water body entering the water purification assembly 100 may be cooled first and then filtered, and the filtered low-temperature purified water is supplied to each water-use component 500, so that the user can directly take the cooled water from the dispenser 503 for use.

During the usage of the refrigeration device 600, the water purification assembly 100 may be connected to an external tap water pipe, that is, an external water source, and the valve assembly 200 may be a one-inlet and three-outlet valve, which has one liquid inlet and three liquid outlets. The liquid inlet of the valve assembly 200 is communicated with the main water outlet 1052 of the water purification assembly 100, and each liquid outlet of the valve assembly 200 is communicated with the first ice maker 501, the second ice maker 502 and the dispenser 503 through corresponding connect pipes respectively. The water purified by the water purification assembly 100 may be selectively dispensed to the first ice maker 501, the second ice maker 502 and the dispenser 503 of the refrigeration device 600.

The purified water output by the water purification assembly 100 is controllably dispensed to the first ice maker 501, the second ice maker 502 and the dispenser 503 through the one-in-three-out valve, which can satisfy ice-make needs of the first ice maker 501 and the second ice maker 502, and the user can also use ice water through the dispenser 503 without opening a door body 603, which is more convenient during using.

Further, by providing the water storage chamber 1041 inside the water purification assembly 100, a traditional water tank structure is integrated with the water purification assembly 100, and a water supply waterway structure for the water-use component 500 is simplified. The simplified water supply waterway can not only extend the flow path of an internal water body, but also facilitate the first-in-first-out of the water body. Meanwhile, water may be stored in the water storage chamber 1041. After the water purification assembly 100 is mounted as a whole in the refrigerator room 601, the water storage chamber 1041 uses the low temperature of the refrigerator room 601 to cool the internal water. The cooled water body is supplied to the dispenser 503, which can improve the user experience.

According to the refrigeration device 600 provided by the present application, by providing the water storage chamber 1041 for water storage in the water purification assembly 100, the water purification assembly 100 is more integrated, and the water purification assembly 100 not only has a purify function, but also has a water storage function. The water tank, which is provided independently from water purification assembly 100 in the related art, is replaced, that is, the water tank is canceled, thereby simplifying a structural design and reducing space occupied by the structure. Meanwhile, connect pipes and connect joints between the water tank and the water purification assembly 100 are canceled, which effectively avoids structural leakage risks, thereby making a product more reliable and user experience better.

Finally, it should be noted that, the above embodiments are only used to illustrate the present application, but not to limit the present application. Although the present application has been described in detail with reference to some embodiments, those skilled in the art should understand that various combinations, modifications, or equivalent replacements of the solutions of the present application do not depart from the scope of the solutions of the present application, and should all cover the scope of the claims of the present application.

1. A water purification assembly, comprising:
an outer shell assembly, wherein an accommodation chamber is provided inside the outer shell assembly;
a filter element, provided inside the accommodation chamber;
an inner shell, provided between the outer shell assembly and the filter element, wherein a first flow channel is provided between the inner shell and the outer shell assembly, and a second flow channel is provided between the inner shell and the filter element; and
a support member, adapted to support the filter element, wherein a water storage chamber is provided between the support member and a bottom wall of the outer shell assembly, and the water storage chamber is communicated with the first flow channel and the second flow channel respectively.

2. The water purification assembly of claim 1, wherein the support member is provided at an inner wall surface of the outer shell assembly, and the water storage chamber is formed inside the support member; or
the support member is provided at an inner wall surface of the inner shell, and the water storage chamber is composed of the support member and at least one of the inner shell and the outer shell assembly.

3. The water purification assembly of claim 2, wherein the support member comprises a support member body and a limit block, wherein the limit block is provided at an outer side wall of the support member body and is suitable for abutting against the inner wall surface of the outer shell assembly,
wherein the support member body has a first end and a second end, the first end is formed with a first water inlet, the first water inlet is communicated with the first flow channel, and the second end is adapted to abut against the filter element.

4. The water purification assembly of claim 3, wherein a first block member is provided at a second end of the support member body, and the first block member abuts against an end portion of the filter element.

5. The water purification assembly of claim 4, wherein the support member body and the first block member are integrally formed,
wherein a block groove is provided at a side of the first block member facing the filter element, and the filter element is embedded in the block groove; and
a protrusion is provided inside the block groove, a third flow channel is provided inside the filter element, and the protrusion extends into the third flow channel.

6. The water purification assembly of claim 3, wherein a limit portion is provided at an outer side wall of the support member body, and the inner shell abuts against the limit portion; and
a first water outlet is provided between the limit portion and a second end of the support member body, and the first water outlet is communicated with the second flow channel.

7. The water purification assembly of claim 1, wherein the outer shell assembly comprises a first outer shell and a second outer shell, and the first outer shell is connected to and at least partially seals the second outer shell.

8. The water purification assembly of claim 1, wherein at least one of the first flow channel and the second flow channel is provided with a flow guide portion, and the flow guide portion extends along a central axis of the inner shell to form a spiral structure.

9. The water purification assembly of claim 1, further comprising: a socket assembly, wherein the socket assembly comprises:
a socket main body, provided with a main water inlet and a main water outlet, wherein a bypass chamber, a dispensing chamber and an operation chamber are provided inside the socket main body, the bypass chamber is communicated with the operation chamber through the dispensing chamber, and the operation chamber is detachably connected to the water purification assembly; and
a valve core assembly, movably provided inside the dispensing chamber and adapted to switch between a first position and a second position,
wherein in case that the valve core assembly is at the first position, the valve core assembly blocks the dispensing chamber and the operation chamber, and the main water inlet is communicated with the main water outlet through the dispensing chamber and the bypass chamber; or
in case that the valve core assembly is at the second position, the valve core assembly blocks the dispensing chamber and the bypass chamber, and the main water inlet is communicated with the main water outlet through the dispensing chamber and the operation chamber.

10. The water purification assembly of claim 9, further comprising: a water-stop assembly, wherein a water-stop chamber is provided inside the outer shell assembly, the water-stop assembly is movably provided at the water-stop chamber, and the water-stop assembly is adapted to switch between a first position and a second position,
wherein a first passage is provided outside the water-stop assembly, a second passage is provided inside the water-stop assembly, and a check valve is provided inside the second passage,
wherein in case that the water-stop assembly is at the first position, the water-stop assembly blocks the first passage, and the check valve blocks the second passage; or
in case that the water-stop assembly is at the second position, the water-stop assembly conducts the first passage, and the check valve conducts the second passage.

11. A refrigeration device, comprising a refrigerator compartment and a water-use component, and a water purification assembly, the water purification assembly comprising:
an outer shell assembly, wherein an accommodation chamber is provided inside the outer shell assembly;
a filter element, provided inside the accommodation chamber;
an inner shell, provided between the outer shell assembly and the filter element, wherein a first flow channel is provided between the inner shell and the outer shell assembly, and a second flow channel is provided between the inner shell and the filter element; and
a support member, adapted to support the filter element, wherein a water storage chamber is provided between the support member and a bottom wall of the outer shell assembly, and the water storage chamber is communicated with the first flow channel and the second flow channel respectively, wherein the water purification assembly is provided inside the refrigeration compartment, and the water-use component is connected to a water outlet of the water purification assembly.

12. The refrigeration device of claim 11, further comprising a valve assembly, wherein a liquid inlet of the valve assembly is communicated with the water outlet of the water purification assembly, and a liquid outlet of the valve assembly is communicated with at least one water-use component.

13. The refrigeration device of claim 11, wherein the water-use component comprises a first ice maker, a second ice maker and a dispenser; and
the refrigeration compartment comprises a refrigerator compartment and a freezer compartment, the first ice maker is provided at the refrigerator compartment, the second ice maker is provided at the freezer compartment, and the dispenser is provided at a door body of the refrigeration device.

14. The refrigeration device of claim 11, wherein at least one of the first flow channel and the second flow channel is provided with a flow guide portion, and the flow guide portion extends along a central axis of the inner shell to form a spiral structure.

15. The refrigeration device of claim 11, further comprising: a socket assembly, wherein the socket assembly comprises:
a socket main body, provided with a main water inlet and a main water outlet, wherein a bypass chamber, a dispensing chamber and an operation chamber are provided inside the socket main body, the bypass chamber is communicated with the operation chamber through the dispensing chamber, and the operation chamber is detachably connected to the water purification assembly; and
a valve core assembly, movably provided inside the dispensing chamber and adapted to switch between a first position and a second position,
wherein in case that the valve core assembly is at the first position, the valve core assembly blocks the dispensing chamber and the operation chamber, and the main water inlet is communicated with the main water outlet through the dispensing chamber and the bypass chamber; or
in case that the valve core assembly is at the second position, the valve core assembly blocks the dispensing chamber and the bypass chamber, and the main water inlet is communicated with the main water outlet through the dispensing chamber and the operation chamber.

16. The refrigeration device of claim 15, further comprising: a water-stop assembly, wherein a water-stop chamber is provided inside the outer shell assembly, the water-stop assembly is movably provided at the water-stop chamber, and the water-stop assembly is adapted to switch between a first position and a second position,
wherein a first passage is provided outside the water-stop assembly, a second passage is provided inside the water-stop assembly, and a check valve is provided inside the second passage,
wherein in case that the water-stop assembly is at the first position, the water-stop assembly blocks the first passage, and the check valve blocks the second passage; or
in case that the water-stop assembly is at the second position, the water-stop assembly conducts the first passage, and the check valve conducts the second passage.

17. The refrigeration device of claim 11, wherein the support member is provided at an inner wall surface of the outer shell assembly, and the water storage chamber is formed inside the support member; or
the support member is provided at an inner wall surface of the inner shell, and the water storage chamber is composed of the support member and at least one of the inner shell and the outer shell assembly.

18. The refrigeration device of claim 17, wherein the support member comprises a support member body and a limit block, wherein the limit block is provided at an outer side wall of the support member body and is suitable for abutting against the inner wall surface of the outer shell assembly,
wherein the support member body has a first end and a second end, the first end is formed with a first water inlet, the first water inlet is communicated with the first flow channel, and the second end is adapted to abut against the filter element.

19. The refrigeration device of claim 18, wherein a first block member is provided at a second end of the support member body, and the first block member abuts against an end portion of the filter element.

20. The refrigeration device of claim 11, wherein the outer shell assembly comprises a first outer shell and a second outer shell, and the first outer shell is connected to and at least partially seals the second outer shell.
